(19) United States
(12) Patent Application Publication
(10) Pub. No.: US 2010/0032485 A1
(43) Pub. Date: Feb. 11, 2010

(54) Card reader

(75) Inventors: Shih-Hung Liao, Hsichih City (TW); Chen-An Wu, Hsichih City (TW); Yu-Chien Chueh, Hsinchih City (TW); Chih-Chien Lin, Hsichih City (TW); Wu-Hsiung Chen, Hsichih City (TW)

Correspondence Address: BACON & THOMAS, PLLC, 625 SLATERS LANE, FOURTH FLOOR, ALEXANDRIA, VA, 22314-1176, US

(73) Assignee: CHANT SINCERE CO., LTD., Hsichih City (TW)

(21) Appl. No.: 12/320,724

(22) Filed: Feb. 3, 2009

(30) Foreign Application Priority Data
Aug. 6, 2008 (TW) 097129948

(51) Int. Cl. G06K 7/06

(52) U.S. Cl. 235/441

(57) ABSTRACT

A card reader includes a housing, a sliding carrier mounted in the housing to carry a USB-configured metal casing, a push tab fastened to the sliding carrier and suspending out of one side of the housing for operation by a user to move the sliding carrier and the USB-configured metal casing to the front position for insertion into a USB port in an external electronic apparatus, a circuit module mounted in the metal casing for electric connection to the external electronic apparatus after insertion of the metal casing into the USB port, a rack mounted in the bottom side of the circuit board and holding a set of conducting terminals for receiving a first electronic card, and an expansion module mounted in the rear side for the contact of a second electronic card that is inserted through a top insertion slot in the housing into a top insertion slot in the sliding carrier.

### BACKGROUND OF THE INVENTION

1. Field of the Invention

The present invention relates to card readers and more particularly, to such a card reader, which allows insertion of two electronic cards in different directions and has a sliding carrier received in the housing thereof to carry a USB-configured metal casing in and out of the housing for insertion into a USB port of an external electronic apparatus.

2. Description of the Related Art

Following the step of the development of high technology and digital multimedia technology, various digitalized electric and electronic products are created. These high-tech electronic products, such as digital camera, digital video camera, cellular telephone, MP3 player, MP4 player, digital recorder and etc. commonly provide multiple functions and use an electronic (memory) card for storing static/dynamic audio and/or video data. For convenient use and easy carrying, electronic products are made having light, thin, short and small characteristics. In consequence, electronic component parts, electronic connectors, electronic cards must be small-sized to satisfy the requirements.

Currently, many electronic (memory) cards are commercially available, including MMC (MultiMediaCard), CF (Compact Flash Card), SMC (Smart Media Card), MS (Memory Stick), SD (Secure Digital Memory Card), SM (SmartMedia), and other mini and micro electronic (memory) cards, such as Mini SD, MS Duo, Trans Flash (Micro SD), M2 (Memory Stick Micro Card), and etc.

Further, a card reader is an interface between a memory card and a computer. Through a USB port, a computer allows data transmission with a card reader. By means of hot swap, a computer can read the storage data of a card reader rapidly. However, regular commercial card readers have a big size, not convenient for carrying. Therefore, a regular card reader cannot be directly connected to a USB port of a computer. For connecting a card reader to a USB port of a computer, a USB cable must be used.

FIG. 10 illustrates a card reader a conventional card reader. According to this design, the card reader comprises a housing A formed of a top cover shell A1 and a bottom cover shell A2, and a circuit board B mounted in the housing A. The top cover shell A1 has a side opening A11. The bottom cover shell A2 has a side opening A21 corresponding to the side opening A11 of the top cover shell A1. The circuit board B has a USB terminal set B1 disposed at its one end, and a memory card terminal set B2 disposed at its other end corresponding to the side openings A11 and A21 of the housing A. During use, a memory card is inserted into the side openings A11 and A21 of the housing A and kept in contact with the memory card terminal set B2 electrically for data reading. This design of card reader is still has drawbacks as follows:
1. Because the circuit board B has a USB terminal set B1 arranged at its one end and a memory card terminal set B2 arranged at its other end, it has a certain length. In consequence, the length of the card reader cannot be minimized for easy carrying and use.
2. The side openings A11 and A21 are disposed at one lateral side of the housing A for the insertion of a memory card. After insertion of a memory card into the side openings A11 and A21 of the housing A, the inserted memory card partially protrudes over one lateral side of the housing A, hindering insertion of the card reader into one USB port of a computer memory or its removal from the computer.

Therefore, it is desirable to provide a compact card reader that eliminates the aforesaid drawbacks.

### SUMMARY OF THE INVENTION

The present invention has been accomplished under the circumstances in view. It is therefore one object of the present invention to provide a card reader, which is small-sized and configured for direct insertion into a USB port of an external electronic apparatus without hindering insertion of a mobile electronic device into a neighbor USB port of the electronic apparatus. It is another object of the present invention to provide a card reader, which can receive two electronic cards in different directions.

To achieve this and other objects of the present invention, the card reader comprises a housing, a sliding carrier, a metal casing, a push tab, a circuit module, and an expansion module. The housing comprises an accommodation chamber, a front opening in communication with the accommodation chamber, a longitudinal slot formed in one lateral side thereof, and a top insertion slot in the top side. The sliding carrier is mounted in the housing and movable relative to the housing between a front position and a rear position. Further, the sliding carrier comprises a top insertion slot in vertical alignment with the top insertion slot of the housing. The metal casing is fixedly mounted in the sliding carrier and insertable into a communication port of an external electronic apparatus when the sliding carrier is moved to the front position where the metal casing suspends outside the housing. The push tab is fastened to the sliding carrier and suspending in the longitudinal sliding slot of the housing for operation by a person to move the sliding carrier between the front position and the rear position. The circuit module comprises a circuit board, which is mounted in the sliding carrier and comprises a contact set electrically connectable to an electric contact set in the communication port of the external electronic apparatus into which the metal casing is inserted, an electrically insulative rack, which is fastened to the bottom side of the circuit board and comprises a bottom receiving space for receiving an electronic card, and a set of conducting terminals mounted in the electrically insulative rack for the contact of the electronic card that is inserted into the bottom receiving space. The expansion module comprises an electrically insulative terminal holder mounted on the front side of the circuit board, and a set of contact terminals mounted in the electrically insulative terminal holder and suspending in the top insertion slot of the sliding carrier for the contact of an electronic card that is inserted through the top insertion slot of the housing into the top insertion slot of the sliding carrier.

### BRIEF DESCRIPTION OF THE DRAWINGS

FIG. 1 is an elevational view of a card reader in accordance with the present invention.

FIG. 2 is an exploded view of the card reader in accordance with the present invention.

FIG. 3 is another exploded view of the card reader in accordance with the present invention.

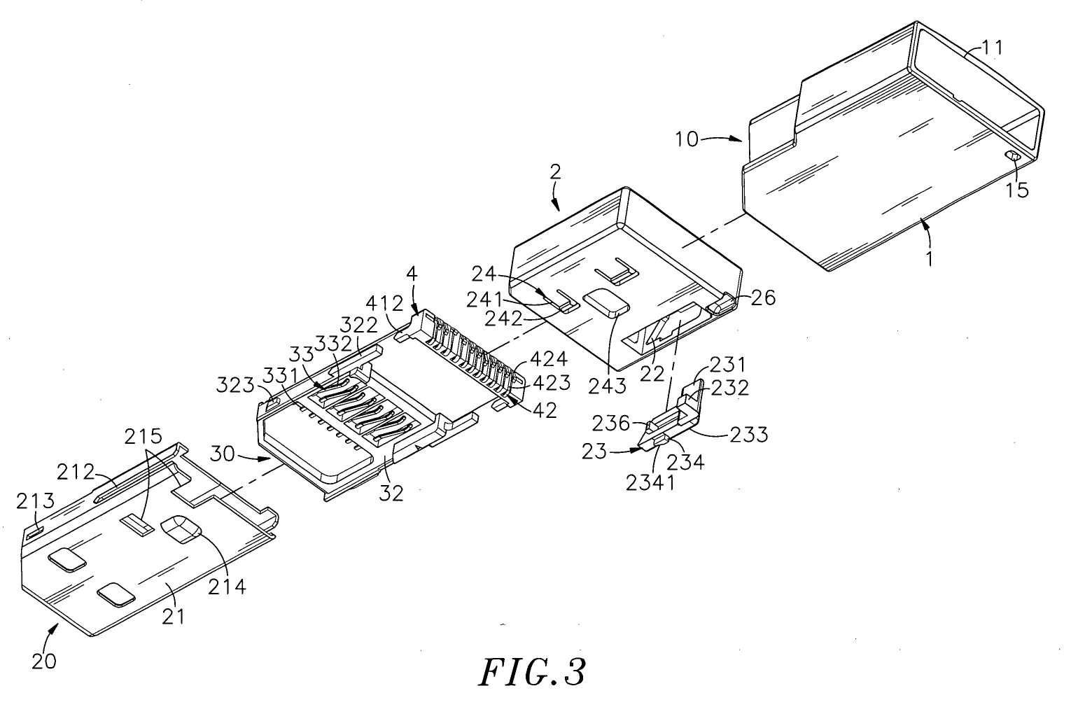

FIG. 4 is a sectional view of the first embodiment of the card reader in accordance with the present invention.

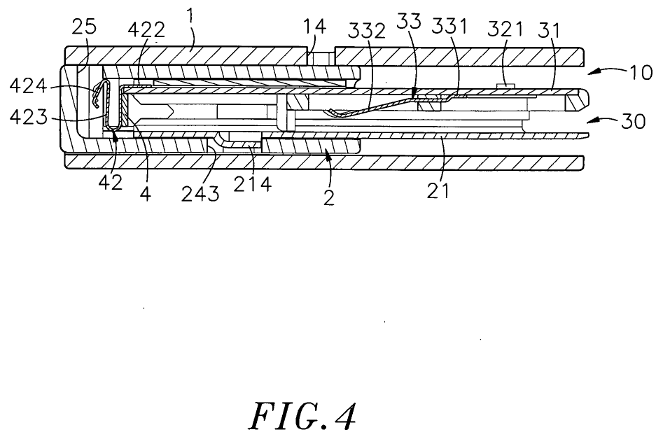

FIG. 5 is a schematic drawing of the present invention, showing push tab pressed.

FIG. 6 is a schematic drawing of the present invention, showing push tab pushed forwards along the longitudinal sliding slot of the electrically insulative housing.

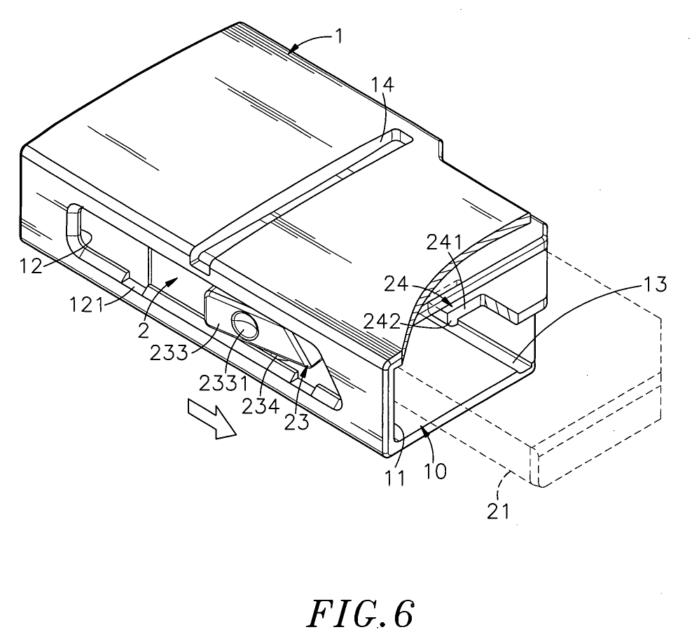

FIG. 7 is another elevational view of the present invention, showing the metal casing of the card reader extended out of the electrically insulative housing.

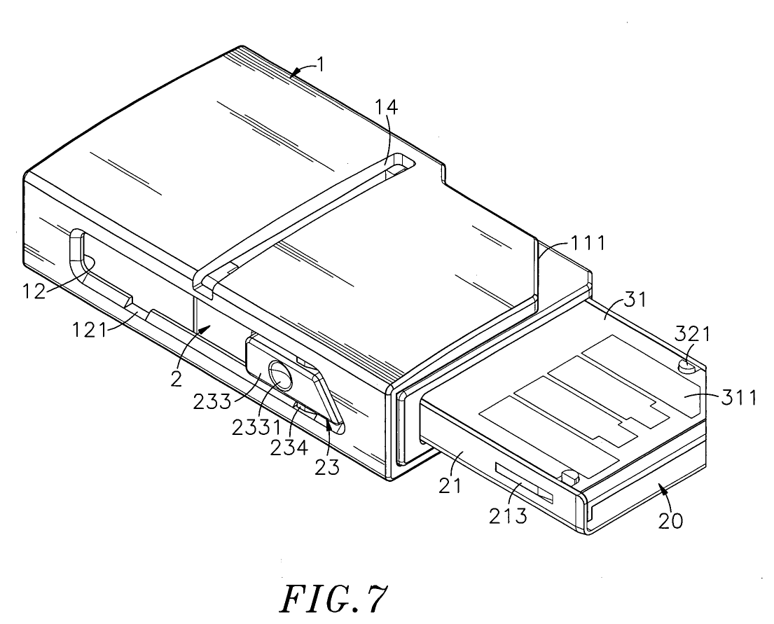

FIG. 8 corresponds to FIG. 7, showing an electronic card inserted into the bottom receiving space in the electrically insulative rack of the circuit module.

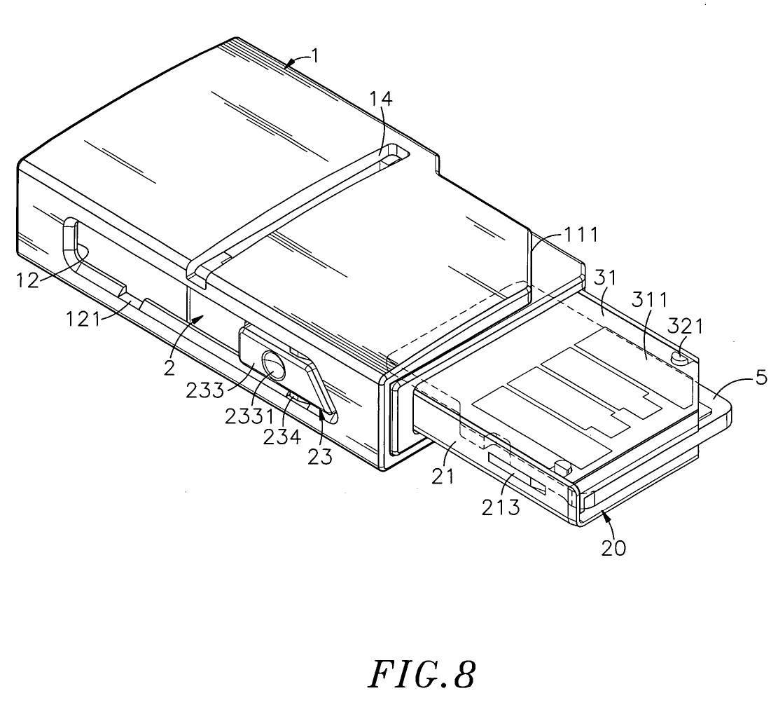

FIG. 9 is a sectional view of the present invention, showing two electronic cards installed in the card reader.

FIG. 10 is an exploded view of a card reader according to the prior art.

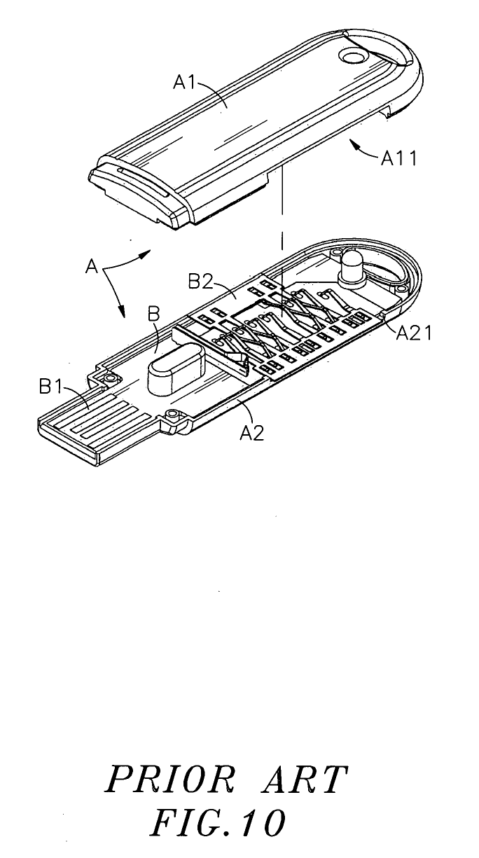

### DETAILED DESCRIPTION OF THE PREFERRED EMBODIMENT

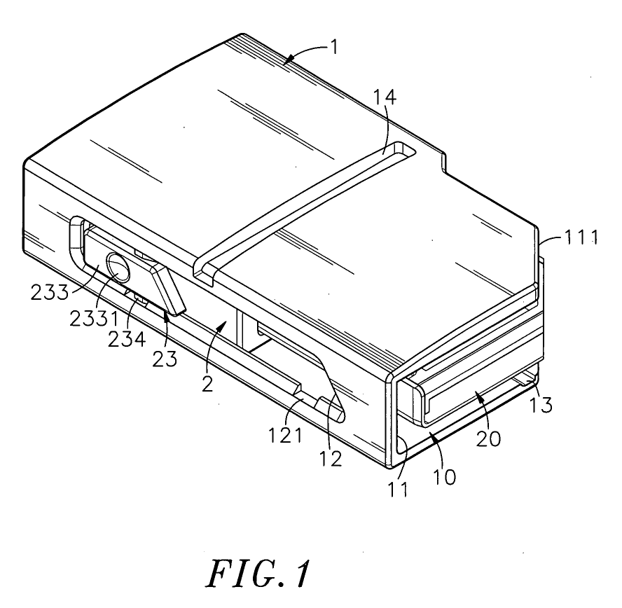

Referring to FIGS. 1˜4, a card reader in accordance with the present invention comprises a housing 1, a sliding carrier 2, and a circuit module 3.

The housing 1 comprises a hollow shell comprising an accommodation chamber 10 adapted to accommodate the sliding carrier 2 and the circuit module 3, an opening 11 in each of the front and rear ends thereof, a notched bevel edge 111 disposed at one lateral side adjacent to the opening 11 in the front end, a longitudinal sliding slot 12 formed in the other lateral side, two pairs of retaining notches 121 symmetrically disposed at two sides in the longitudinal sliding slot 12, and a sliding way 13 formed in the accommodation chamber 10 between the two openings 11.

The sliding carrier 2 has a metal casing 21 fixedly mounted therein and extending out of a front opening 211 thereof. The metal casing 21 extends out of the front opening 211 of the sliding carrier 2, comprising front and rear locating slots 212 and 213 formed in its two opposite lateral sides and a bottom locating block 214 protruded from its bottom side. Further, the metal casing 21 is configured subject to a USB plug for insertion into a USB port and thereof, defining therein an accommodation space 20 for accommodating the circuit module 3. The sliding carrier 2 has a side hole 22 corresponding to the longitudinal sliding slot 12 of the housing 1, a bottom locating hole 243 for engagement with the bottom locating block 214 of the metal casing 21. A push tab 23 is mounted in the side hole 22. The push tab 23 comprises a base 231, a stop rod 232 perpendicularly extended from the base 231, a springy arm 233 extended from the front side of the base 231 and suspending in the longitudinal sliding slot 12 of the housing 1, two retaining blocks 234 respectively protruded from top and bottom sides of the springy arm 233 and selectively engaged into one pair of retaining notches 121 of the housing 1, a slot 235 cut through the connection area between the base 231 and the springy arm 233, a finger recess 2331 formed on the outer side of the springy arm 233, and a cushion block 236 protruded from the inner side of the springy arm 233 remote from the base 231 for stopping against one lateral side of the metal casing 21. The sliding carrier 2 further comprises a plurality of cut holes 24 formed in the bottom wall corresponding to the sliding way 13 of the housing 1, and a spring strip 241 suspending in each cut hole 24. Each spring strip 241 has a sliding block 242 stopped against the surface of the sliding way 13 to stabilize sliding movement of the sliding carrier 2 along the sliding way 13.

The circuit module 3 comprises a circuit board 31, an electrically insulative rack 32, and a set of conducting terminals 33. The circuit board 31 is mounted in the accommodation space 20 inside the metal casing 21, comprising a USB contact set 311 disposed at its front side and a plurality of mounting holes 312 beyond the front side that carries the USB contact set 311. The electrically insulative rack 32 comprises a plurality of mounting rods 321 respectively fastened to the mounting holes 312 of the circuit board 31, and front and rear locating ribs 322 and 323 disposed at its two opposite lateral sides corresponding to the front and rear locating slots 212 and 213 of the metal casing 21. The conducting terminals 33 are mounted in the electrically insulative rack 32. Each conducting terminal 33 has a rear bonding portion 331 bonded to the circuit board 31 and electrically connected to one corresponding contact of the USB contact set 311, and a front contact portion 332 obliquely suspending in a bottom receiving space 30 in the bottom side of the electrically insulative rack 32.

During installation, the circuit module 3 is inserted into the accommodation space 20 of the metal casing 21 to force the front and rear locating ribs 322 and 323 of the electrically insulative rack 32 into engagement with the front and rear locating slots 212 and 213 of the metal casing 21, and then the metal casing 21 is inserted into the sliding carrier 2 to force the bottom locating block 214 into engagement with the bottom locating hole 243 of the sliding carrier 2. Thereafter, force the stop rod 232 of the base 231 of the push tab 23 into engagement with a rear part of the metal casing 21, and then insert the sliding carrier 2 into the accommodation chamber 10 of the housing 1 to force the sliding blocks 242 into close contact with the surface of the sliding way 13 in the housing 1. After the sliding carrier 2 has been fully inserted into the inside of the housing 1, the cushion block 236 of the push tab 23 is stopped against one lateral side of the sliding carrier 2, and the retaining blocks 234 are respectively forced into engagement the two retaining notches 121 near the rear end of the longitudinal sliding slot 12 of the housing 1 to lock the sliding carrier 2 to the housing 1 in the received position. Because the cushion block 236 is stopped against one lateral side of the sliding carrier 2, operating the springy arm 233 to move the push tab 23 does not cause the springy arm 233 to be jammed in a gap between the sliding carrier 2 and the housing 1.

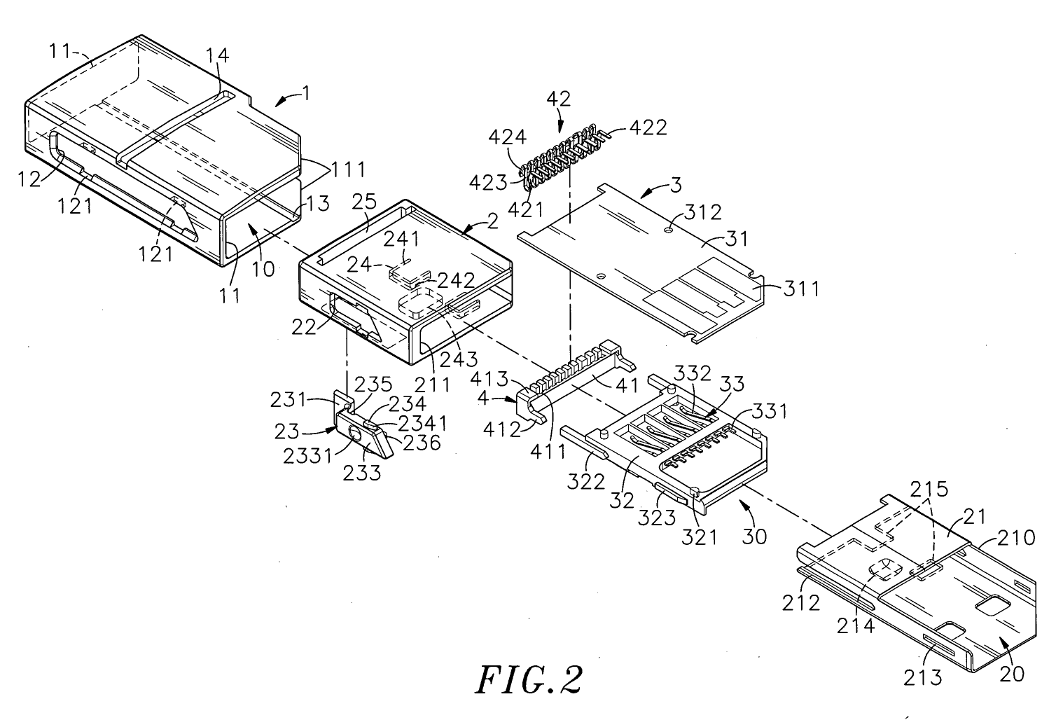

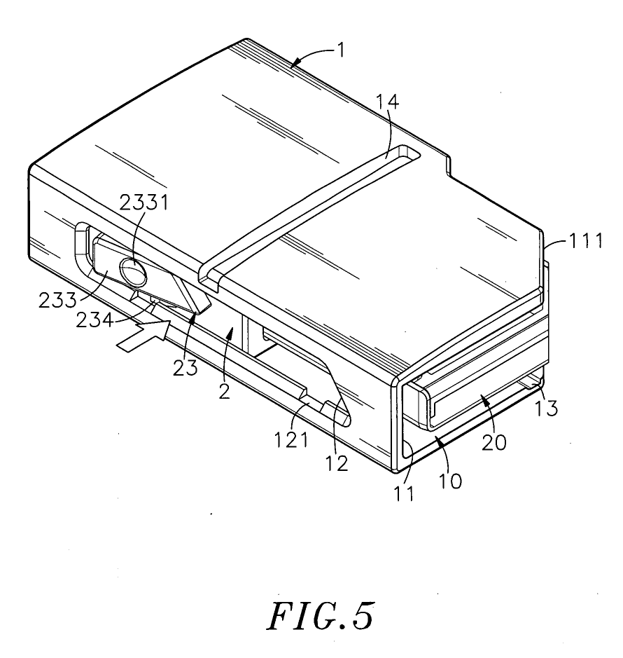

Referring to FIGS. 5˜8 and FIG. 2 again, when using the card reader, press one finger on the finger recess 2331 at the springy arm 233 of the push tab 23 to force the springy arm 233 inwards toward the inside of the sliding carrier 2, thereby disengaging the retaining blocks 234 from the retaining notches 121 near the rear end of the longitudinal sliding slot 12 of the housing 1. At this time, the user can push the push tab 23 to move the sliding carrier 2 along the sliding way 13 of the housing 1 toward the outside of the housing 1. By means of the respective guide surface portions 2341 of the retaining blocks 234, the push tab 23 is smoothly moved along the longitudinal sliding slot 12 to push the sliding carrier 2 and the metal casing 21 out of the front end of housing 1. During sliding movement of the sliding carrier 2 along the sliding way 13 of the housing 1, the spring strips 241 are elastically movably up and down between the respective cut holes 24 in the bottom wall of the sliding carrier 2 and respective holes 215 in the bottom wall of the metal casing 21, and the sliding blocks 242 of the spring strips 241 are stopped against the surface of the sliding way 13 to stabilize sliding movement of the sliding carrier 2 along the sliding way 13, avoiding friction resistance or interference between the housing 1 and the sliding carrier 2. Therefore, no noise will be produced during sliding movement of the sliding carrier 2 relative to the housing 1. Further, by means of stopping the cushion block 236 of the springy arm 233 against one lateral side of the sliding carrier 2, the springy arm 233 of the push tab 23 will never be jammed in between the housing 1 and the sliding carrier 2 during sliding movement of the sliding carrier 2 relative to the housing 1.

After the sliding carrier 2 has been pushed to the front end of the housing 1 to suspend the top-open rear part 210 of the metal casing 21 outside the housing 1, release the hand from the push tab 23, enabling the retaining blocks 234 of push tab 23 to be forced by the springy material property of the springy arm 233 into engagement with the retaining notches 121 near the front end of the longitudinal sliding slot 12 of the housing 1 respectively, thereby locking the sliding carrier 2 and the metal casing 21 to the housing 1 in the extended position. At this time, insert an electronic card 5 into the bottom receiving space 30 of the electrically insulative rack 32 to keep the electronic card 5 in contact with the front contact portions 332 of the conducting terminals 33 in the electrically insulative rack 32 electrically. Thereafter, insert the USB configured metal casing 21 into one USB port of an electronic apparatus (not shown) to electrically connect the USB contact set 311 to the corresponding contact set in the USB port of the electronic apparatus for two-way data transfer between the electronic card 5 and the electronic apparatus. Because the rear part 210 of the metal casing 21 has a top-open design, diminishing material consumption. Further, because the electronic card 5 is received in the bottom receiving space 30 of the electrically insulative rack 32 within the sliding carrier 2, it does not an extra space of the metal casing 21, therefore the dimension of the card reader is greatly reduced, meeting thin-shell requirement for easy carrying.

Further, when wishing to receive the metal casing 21 back to the inside of the accommodation chamber 10 of the housing 1, press the finger recess 2331 to disengage the retaining blocks 234 of the push tab 23 from the retaining notches 121 near the front end of the longitudinal sliding slot 12 of the housing 1, and then push the push tab 23 backwards to move the sliding carrier 2 to the rear end of the housing 1, thereby receiving the metal casing 21 in the inside of the housing 1. Further, when wishing to remove the electronic card 5 from the metal casing 21 and the bottom receiving space 30 of the electrically insulative rack 32, the user can directly pull one corner edge of the electronic card 5 that extends out of the notched bevel edge 111, moving the electronic card 5 out of the metal casing 21 and the electrically insulative rack 32. Further, when mounting the electronic card 5, the electronic card 5 is directly inserted into the bottom receiving hole 30 of the electrically insulative rack 32. This electronic card installation manner is quite simple without directional limitation. Further, the sliding carrier 2 has an opening 26 in one corner thereof. The housing 1 has a through hole 15 corresponding to the opening 26 for the mounting of a cord member for hanging or carrying by hand.

Further, the aforesaid electronic cards 5 can be CF (Compact Flash), MS (Memory Stick), SD (Secure Digital), MMC (Multi Media Card), SM (Smart Media), Mini SD (Mini Secure Digital), MS Duo, Micro SD (Micro Secure Digital), M2 (Memory Stick Micro Card), or any of a variety of other memory cards. Further, the aforesaid electronic apparatus can be a desktop computer, notebook computer, mobile telephone, PAD, or any of a variety of other electronic devices capable for two-way data communication with the electronic card 5 in the card reader.

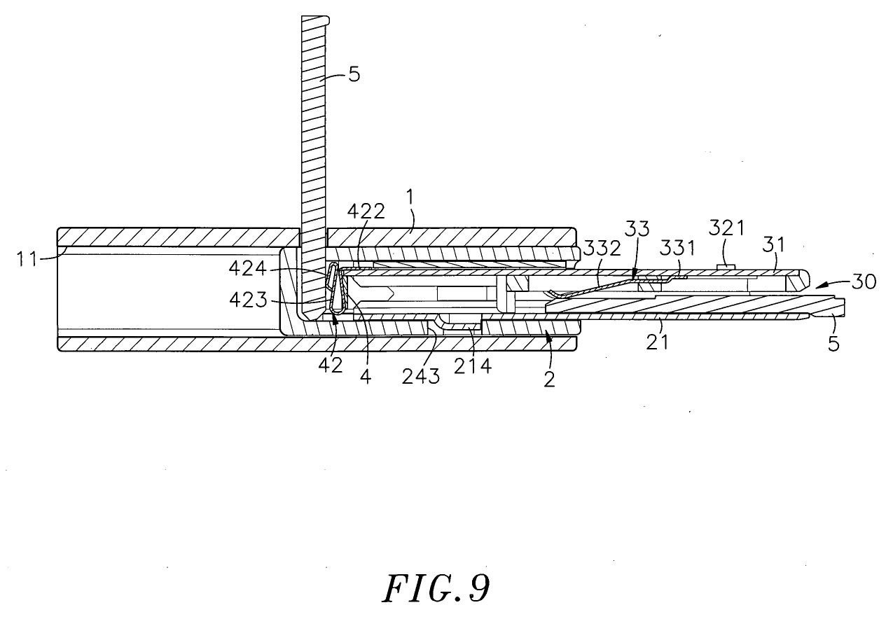

Referring to FIG. 9 and FIGS. 2˜4 again, the housing 1 further comprises a top insertion slot 14 in perpendicular communication with the sliding way 13 in the accommodation chamber 10. The sliding carrier 2 has a top insertion slot 25 corresponding to the top insertion slot 14 of the housing 1. Further, an extension module 4 is connected to the rear side of the circuit board 31 of the circuit module 3. The expansion module 4 comprises an electrically insulative terminal holder 41, and a set of contact terminals 42 mounted in the electrically insulative terminal holder 41. Each contact terminal 42 has a base 421 mounted in one respective terminal slot 411 in the electrically insulative terminal holder 41, a bonding portion 422 extended from the base 421 at one side and bonded to a respective contact at the circuit board 31, and a contact portion 424 suspending in the top insertion slot 25, and a U-shaped spring arm 423 connected between the base 421 and the contact portion 424.

During installation of the expansion module 4, attach the electrically insulative terminal holder 41 to the front side of the circuit board 31 at right angles to force two forwardly extending locating rods 412 of the electrically insulative terminal holder 41 into engagement with the two locating slots 212 at the front side of the metal casing 21 and two top pressure flanges 413 of the electrically insulative terminal holder 41 into engagement with the two front corner edges of the circuit board 31, and then solder the bonding portions 422 of the contact terminals 42 to the respective contacts at the circuit board 31 to have the contact portions 424 of the contact terminals 42 be suspending in the top insertion slot 25 of the sliding carrier 2 corresponding to the top insertion slot 14 of the housing 1.

During use, the user can push the push tab 23 to move the sliding carrier 2 to the front end of the housing 1 and to suspend the metal casing 21 outside the electrically insulative housing 1. At this time, the top insertion slot 25 of the sliding carrier 2 is kept in vertical alignment with the top insertion slot 14 of the housing 1. Thus, the user can insert one electronic card 5 into the top insertion slot 14 of the housing 1 and the top insertion slot 25 of the sliding carrier 2. After the electronic card 5 has been inserted into the top insertion slot 25 of the sliding carrier 2, the electronic card 5 is kept in contact with the contact portions 424 of the contact terminals 42 electrically and held in position against vibration. Thereafter, the user can insert another electronic card 5 into the bottom receiving space 30 of the electrically insulative rack 32 to electrically connect the electronic card 5 to the contact portions 332 of the conducting terminals 33 in the electrically insulative rack 32. Thus, the card reader can be used with two electronic cards at the same time. This expansion characteristic widens the applicability of the card reader and also greatly enhances its market compatibility.

Although particular embodiments of the invention have been described in detail for purposes of illustration, various modifications and enhancements may be made without departing from the spirit and scope of the invention. Accordingly, the invention is not to be limited except as by the appended claims.

Although a particular embodiment of the invention has been described in detail for enabling any person skilled in the art to know the invention, various modifications and enhancements may be made without departing from the spirit and scope of the invention. Any modifications and enhancements shall not depart from the spirit and scope of the invention. The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiment is chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated.

What the invention claimed is:

1. A card reader, comprising:
a housing, said electrically insulative housing comprising an accommodation chamber, a front opening in communication with said accommodation chamber, and a longitudinal sliding slot formed in one lateral side thereof;
a sliding carrier mounted in said housing and movable relative to said housing between a front position and a rear position;
a metal casing fixedly mounted in said sliding carrier and insertable into a communication port of an external electronic apparatus when said sliding carrier is moved to said front position where said metal casing suspends outside said housing;
a push tab fastened to said sliding carrier and suspending in said longitudinal sliding slot of said housing for operation by a person to move said sliding carrier between said front position and said rear position; and
a circuit module, said circuit module comprising a circuit board mounted in said sliding carrier, said circuit board comprising a contact set electrically connectable to an electric contact set in said communication port of said external electronic apparatus into which said metal casing is inserted.

2. The card reader as claimed in claim 1, wherein said housing comprises two front retaining notches and two rear retaining notches respectively formed in top and bottom sides in said longitudinal sliding slot and respectively disposed near front and rear ends of said longitudinal sliding slot; said push tab comprises a base, a stop rod perpendicularly extended from said base and fastened to said metal casing, a springy arm forwardly extending from said base, two retaining blocks respectively protruded from top and bottom sides of said springy arm and selectively engageable into said two front retaining notches and said two rear retaining notches of said housing to lock said sliding carrier in one of said front position and said rear position, a slot cut through the connection area between said base and said springy arm, and a cushion block protruded from one side of said spring arm remote from said base and stopped against one lateral side of said sliding carrier.

3. The card reader as claimed in claim 1, wherein said housing defines therein a longitudinally extending sliding way for guiding movement of said sliding carrier between said front position and said rear position; said sliding carrier comprises at least one cut hole in a bottom wall thereof and a spring strip suspending in each said cut hole that has a sliding block stopped against said longitudinally extending sliding way to guide movement of said sliding carrier along said longitudinally extending sliding way.

4. The card reader as claimed in claim 1, wherein said sliding carrier comprises a side hole corresponding to said longitudinal sliding slot of said housing for accommodating said push tab, and a bottom locating hole in a bottom wall thereof; said metal casing comprises a bottom locating block protruded from a bottom wall thereof and engaged into said bottom locating hole of said sliding carrier.

5. The card reader as claimed in claim 1, wherein said metal casing is configured subject to a USB plug for insertion into a USB port of said external electronic apparatus, defining therein an accommodation space that accommodates said circuit module; said contact set of said circuit board is configured subject to USB standard.

6. A card reader, comprising;
a housing, said housing comprising an accommodation chamber, a front opening in communication with said accommodation chamber, and a longitudinal sliding slot formed in one lateral side thereof;
a sliding carrier mounted in said housing and movable relative to said housing between a front position and a rear position;
a metal casing fixedly mounted in said sliding carrier and insertable into a communication port of an external electronic apparatus when said sliding carrier is moved to said front position where said metal casing suspends outside said housing;
a push tab fastened to said sliding carrier and suspending in said longitudinal sliding slot of said housing for operation by a person to move said sliding carrier between said front position and said rear position; and
a circuit module, said circuit module comprising a circuit board mounted in said sliding carrier, said circuit board comprising a contact set electrically connectable to an electric contact set in said communication port of said external electronic apparatus into which said metal casing is inserted, an electrically insulative rack fastened to a bottom side of said circuit board, said electrically insulative rack comprising a bottom receiving space for receiving an electronic card, and a set of conducting terminals mounted in said electrically insulative rack for the contact of said electronic card that is inserted into said bottom receiving space.

7. The card reader as claimed in claim 6, wherein said housing comprises two front retaining notches and two rear retaining notches respectively formed in top and bottom sides in said longitudinal sliding slot and respectively disposed near front and rear ends of said longitudinal sliding slot; said push tab comprises a base, a stop rod perpendicularly extended from said base and fastened to said metal casing, a springy arm forwardly extending from said base, two retaining blocks respectively protruded from top and bottom sides of said springy arm and selectively engageable into said two front retaining notches and two rear retaining notches of said electrically insulative housing to lock said sliding carrier in one of said front position and said rear position, a slot cut through the connection area between said base and said springy arm, and a cushion block protruded from one side of said spring arm remote from said base and stopped against one lateral side of said sliding carrier.

8. The card reader as claimed in claim 6, wherein said housing defines therein a longitudinally extending sliding way for guiding movement of said sliding carrier between said front position and said rear position; said sliding carrier comprises at least one cut hole in a bottom wall thereof and a spring strip suspending in each said cut hole that has a sliding block stopped against said longitudinally extending sliding way to guide movement of said sliding carrier along said longitudinally extending sliding way.

9. The card reader as claimed in claim 6, wherein said sliding carrier comprises a side hole corresponding to said longitudinal sliding slot of said housing for accommodating said push tab, and a bottom locating hole in a bottom wall thereof; said metal casing comprises a bottom locating block protruded from a bottom wall thereof and engaged into said bottom locating hole of said sliding carrier.

10. The card reader as claimed in claim 6, wherein said metal casing is configured subject to a USB plug for insertion into a USB port of said external electronic apparatus, defining therein an accommodation space that accommodates said circuit module; the contact set of said circuit board is configured subject to USB standard.

11. The card reader as claimed in claim 6, wherein each said conducting terminal comprises a bonding portion bonded to a respective contact at said circuit board and a contact portion suspending in said bottom receiving space for the contact of an electronic card that is inserted into said bottom receiving space.

12. A card reader, comprising:
an electrically insulative housing, said housing comprising an accommodation chamber, a front opening in communication with said accommodation chamber, a longitudinal sliding slot formed in one lateral side thereof, and a top insertion slot in communication with said accommodation chamber;
a sliding carrier mounted in said housing and movable relative to said housing between a front position and a rear position, said sliding carrier comprising a top insertion slot in vertical alignment with said top insertion slot of said housing;
a metal casing fixedly mounted in said sliding carrier and insertable into a communication port of an external electronic apparatus when said sliding carrier is moved to said front position where said metal casing suspends outside said housing;
a push tab fastened to said sliding carrier and suspending in said longitudinal sliding slot of said electrically insulative housing for operation by a person to move said sliding carrier between said front position and said rear position;
a circuit module, said circuit module comprising a circuit board mounted in said sliding carrier, said circuit board comprising a contact set electrically connectable to an electric contact set in said communication port of said external electronic apparatus into which said metal casing is inserted; and
an expansion module, said expansion module comprising an electrically insulative terminal holder perpendicularly connected to a front side of said circuit board, and a set of contact terminals mounted in said electrically insulative terminal holder and suspending in said top insertion slot of said sliding carrier for the contact of an electronic card that is inserted through said top insertion slot of said electrically insulative housing into said top insertion slot of said sliding carrier.

13. The card reader as claimed in claim 11, wherein said housing comprises two front retaining notches and two rear retaining notches respectively formed in top and bottom sides in said longitudinal sliding slot and respectively disposed near front and rear ends of said longitudinal slot; said push tab comprises a base, a stop rod perpendicularly extended from said base and fastened to said metal casing, a springy arm forwardly extending from said base, two retaining blocks respectively protruded from top and bottom sides of said springy arm and selectively engageable into said two front retaining notches and said two rear retaining notches of said housing to lock said sliding carrier in one of said front position and said rear position, a slot cut through the connection area between said base and said springy arm, and a cushion block protruded from one side of said spring arm remote from said base and stopped against one lateral side of said sliding carrier.

14. The card reader as claimed in claim 11, wherein said housing defines therein a longitudinally extending sliding way for guiding movement of said sliding carrier between said front position and said rear position; said sliding carrier comprises at least one cut hole in a bottom wall thereof and a spring strip suspending in each said cut hole that has a sliding block stopped against said longitudinally extending sliding way to guide movement of said sliding carrier along said longitudinally extending sliding way.

15. The card reader as claimed in claim 11, wherein said sliding carrier comprises a side hole corresponding to said longitudinal sliding slot of said housing for accommodating said push tab, and a bottom locating hole in a bottom wall thereof; said metal casing comprises a bottom locating block protruded from a bottom wall thereof and engaged into said bottom locating hole of said sliding carrier.

16. The card reader as claimed in claim 11, wherein said metal casing is configured subject to a USB plug for insertion into a USB port of said external electronic apparatus, defining therein an accommodation space that accommodates said circuit module; the contact set of said circuit board is configured subject to USB standard.

17. The card reader as claimed in claim 11, wherein said circuit module further comprises an electrically insulative rack fastened to a bottom side of said circuit board, said electrically insulative rack comprising a bottom receiving space for receiving an electronic card, and a set of conducting terminals mounted in said electrically insulative rack for the contact of an electronic card that is inserted into said bottom receiving space.

18. The card reader as claimed in claim 11, wherein said electrically insulative terminal holder of said expansion module comprises a plurality of terminal slots for accommodating said contact terminals; each said contact terminal of said expansion module comprises a base mounted in one said terminal slot of said electrically insulative terminal holder, a bonding portion bonded to one respective contact at said circuit board, a contact portion suspending in said top insertion slot of said sliding carrier, and a U-shaped spring arm connected between said base and said contact portion of the respective contact terminal.

19. The card reader as claimed in claim 17, wherein said electrically insulative housing comprises a notched bevel edge at one lateral side of the front opening thereof for enabling one corner edge of an electronic card that is inserted into said bottom receiving space to expose to the outside of said sliding carrier and said metal casing.
